(19) United States
(12) Patent Application Publication
(10) Pub. No.: US 2009/0158293 A1
(43) Pub. Date: Jun. 18, 2009

(54) Information processing apparatus

(75) Inventor: Nobuki Kajihara, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/991,372

(22) PCT Filed: Jul. 13, 2006
(86) PCT No.: PCT/JP2006/313957

§ 371 Date: Mar. 3, 2008

(30) Foreign Application Priority Data
Sep. 5, 2005 (JP) 2005-256324

(51) Int. Cl. G06F 9/48; G06F 11/00

(52) U.S. Cl. 718/106

(57) ABSTRACT

A program rewriting time is reduced when a large scale process is executed while a program having reconfigurable hardware is being rewritten. When the large scale process is processed by being divided into a smaller process unit, even if the process content is dynamically changed, the program will be flexibly rewritten, and the schedule of execution will be managed, thereby ensuring that an efficient process can be executed. Scheduler 45 controls the program loading to reconfigurable hardware 30 and the execution for a plurality of tasks to reduce a program loading time. Job manager 44 refers to a plurality of pieces of job information configured with a plurality of tasks stored in job information store 43, and manages the tasks to be executed according to a status in executing a job, thereby realizing an efficient process.

### TECHNICAL FIELD

The present invention relates to an information processing apparatus using reconfigurable hardware which can efficiently process a variety of processes using a small amount of hardware resources.

### BACKGROUND ART

An information processing apparatus using reconfigurable hardware such as an FPGA (Field Programmable Gate Array) and a PLD (Programmable Logic Device) can process at a higher rate than processing by a CPU, a DSP, and the like. A variety of processing operations can be processed with a small amount of hardware resource by using a programmable device in which a program of a reconfigurable hardware can be sequentially rewritten according to the process content. In an information processing apparatus using such a reconfigurable hardware, a program is rewritten when it becomes necessary according to the progress of the processing operation. Alternatively, a program is rewritten based on information that is obtained by previously and statically analyzing the entire processing operation (e.g. refer to Japanese Patent Laid-Open 10-256383).

### DISCLOSURE OF THE INVENTION

However, there has been the following problem in such a conventional information processing apparatus.

The first problem is that the time necessary for loading a program is, generally, measurably large compared with the time necessary for processing a task when a program of the reconfigurable hardware is changed for each task to be processed. In communication, network process, media process, and the like, several processes are sequentially executed for a series of input data. For example, in an encoder of JPEG (Joint Photographic Experts Group), it is necessary to execute a series of processes (referred to as task) such as a color conversion, a sampling, a DCT (Discrete Cosine Transform) transform, a quantization, an entropy encoding. A group of processes (in this case, JPEG encoder) configured with such a series of tasks are referred to as a job. When such processes are executed by the reconfigurable hardware, in the related art, the process divides a job into several tasks, prepares programs for the reconfigurable hardware according to each task, and loads the programs to the reconfigurable hardware according to switching the tasks.

However, a program is generally loaded to the reconfigurable hardware by transferring the program stored in an external memorizing medium to the reconfigurable hardware. Thus, it takes a longer time to load the programs to the reconfigurable hardware as compared with a case of a processor such as a CPU and a DSP. Thus, when each program loading time is longer than the time for processing each task, the system performance is limited by the program loading time, which results in an impractical situation in many cases.

While there is also reconfigurable hardware which can previously store a plurality of programs, and switch tasks in a short time, when the number of storable programs is limited, and when the number of programs to be stored exceeds the limit, it becomes necessary to transfer the programs from the external memorizing medium, so that the same problem is caused.

The second problem is that it is difficult or impossible to efficiently perform processing in a static task scheduling method when a job to be processed is not previously fixed. When a job configuration such as a task to be processed, a dependency relation between tasks, and an executing order is statically apparent by previously analyzing the whole of process, the task execution schedule can be managed according to the progress in processing a job. However, for example, as in a network process, when a process (job structure) to be applied to data is different according to the arriving data, a static schedule can not be applied. It is necessary to dynamically generate a job according to the arriving data, select and execute an executable task, and manage the job progress based on executing the task.

In summary, there have been the following two problems in the conventional information processing apparatus.

(1) When a program of the reconfigurable hardware is changed for each task to be processed, generally, the time necessary for loading the program is nonnegligibly large compared with the time necessary for processing the task.

(2) When a job to be processed is not previously fixed, it is difficult or impossible to efficiently perform processing in a static task scheduling method.

An object of the present invention is to provide a system which can cause an overhead of a program loading time to be small when loading a program of the reconfigurable hardware according to the process and can efficiently perform a large scale of process even in the reconfigurable hardware whose hardware scale is limited, in an information processing apparatus using reconfigurable hardware.

Another object of the present invention is to provide a system which can efficiently perform processing by dynamically managing the process progress even when the schedule for loading and executing a program can not previously and statically be determined in an information processing apparatus using the reconfigurable hardware.

To achieve the above objects, the information processing apparatus of the present invention is provided with reconfigurable hardware, an input output data store, and a controller.

The reconfigurable hardware can load one or more programs according to the process content of a task to be executed, and can execute one or more programs of one or more loaded programs at the same time. The input output data store stores input output data to be processed in the reconfigurable hardware. The controller controls loading the programs to the reconfigurable hardware and executing the programs.

The controller is configured with a program store, a task information store, a job information store, a job manager, and a scheduler.

The program store stores a plurality of programs to be loaded to the reconfigurable hardware.

The task information store stores task information indicating a plurality of tasks executable by the same program for each program stored in the program store.

The job information store stores job information indicating a dependency relation between each task included in a job which is a group of process units configured with a plurality of tasks.

The job manager selects an executable task according to the job information, stores task information of the selected task in the task information store, and updates the job information according to progress in executing the task.

The scheduler selects one or more tasks executable by a program from the task information store, and selects a program necessary for executing the selected tasks from the program store. The scheduler loads the selected program to the reconfigurable hardware and manages the schedule, and controls the reconfigurable hardware to execute the tasks and manages the schedule. Furthermore, the scheduler notifies the progress status in executing the tasks to the job manager.

### BRIEF DESCRIPTION OF THE DRAWINGS

FIG. 1 is a block diagram illustrating a configuration of an information processing apparatus of the first exemplary embodiment of the present invention;

FIG. 2 is a diagram illustrating a configuration example of task information 60 stored in task information store 42 of FIG. 1;

FIG. 3A is a diagram illustrating an aspect of managing a plurality of pieces of task information for each program 20 in task information store 42 of FIG. 1;

FIG. 3B is a diagram illustrating a configuration example of task queue 70;

FIG. 4 is a diagram illustrating a configuration example of one job information 50 stored in job information store 43 of FIG. 1;

FIG. 5 is a diagram illustrating a configuration example of reconfigurable hardware 30 of FIG. 1;

FIG. 6 is a diagram illustrating another configuration example of processor 32 of FIG. 5;

FIG. 7 is a flowchart illustrating an operation example of job manager 44 of FIG. 1;

FIG. 8 is a flowchart illustrating an operation example of scheduler 45 of FIG. 1; and

FIG. 9 is a block diagram illustrating a configuration of an information processing apparatus of the second exemplary embodiment of the present invention.

### BEST MODE FOR CARRYING OUT THE INVENTION

Next, exemplary embodiments of the present invention will be described in detail referring to the drawings.

### First Exemplary Embodiment

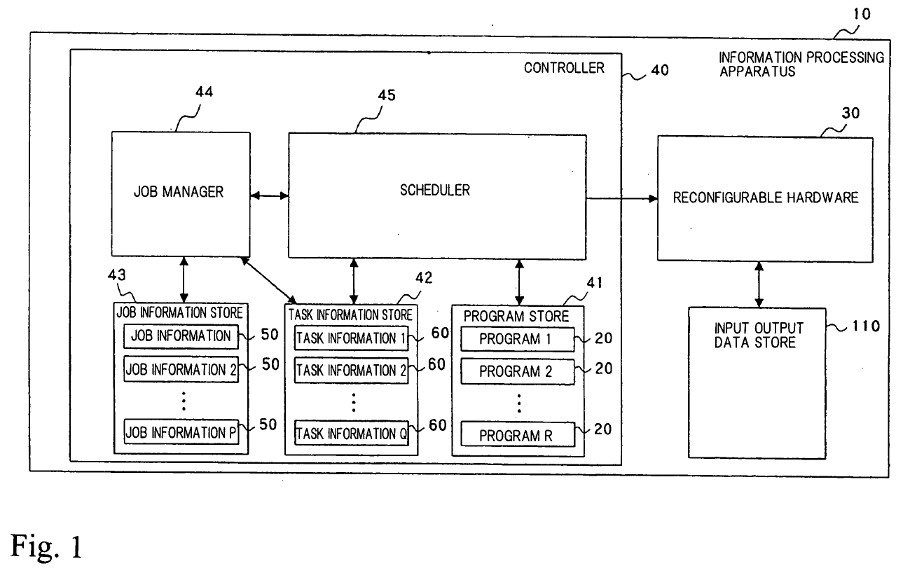

FIG. 1 illustrates a configuration example of an information processing apparatus of the first exemplary embodiment of the present invention. As illustrated in FIG. 1, information processing apparatus 10 of the present exemplary embodiment is configured with reconfigurable hardware 30, input output data store 110, and controller 40.

Controller 40 is configured with program store 41, task information store 42, job information store 43, job manager 44, and scheduler 45.

Reconfigurable hardware 30 can load one or more programs 20, and changes a hardware configuration according to loaded programs 20 to execute a prescribed process. Reconfigurable hardware 30 can execute one or more programs 20 at the same time. If it is enough to load one program 20 and to execute one program 20, reconfigurable hardware 30 can be realized by using an FPGA (Field Programmable Gate Array).

Input output data store 110 stores input output data to be processed by reconfigurable hardware 30.

Program store 41 stores a plurality of programs 20 to be loaded in reconfigurable hardware 30. Loaded programs 20 are uniquely identified by a program identifier, and the like.

Task information store 42 stores task information indicating a plurality of tasks which can be executed by the same program for each of programs 20 stored in program store 41. Task information 60 holds information necessary for reconfigurable hardware 30 to execute tasks.

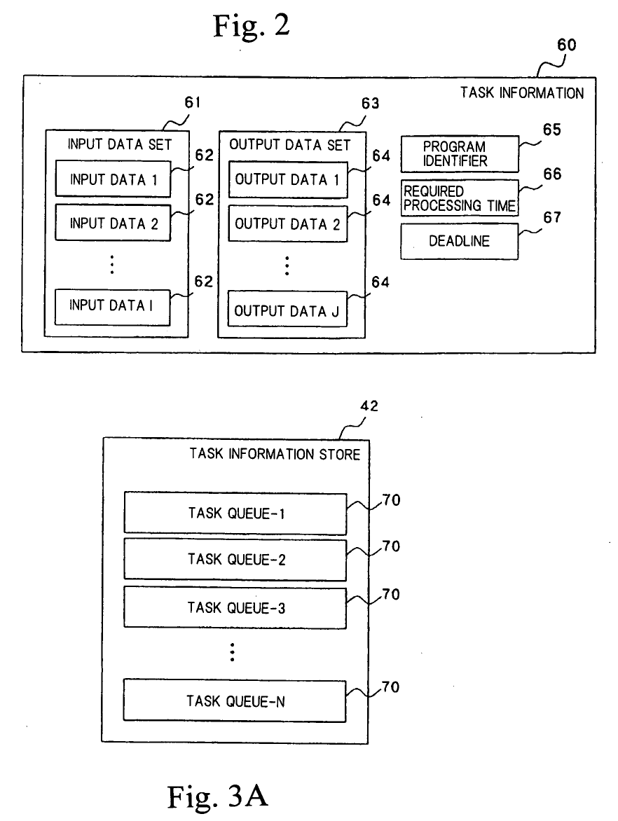

Next, FIG. 2 illustrates a configuration example of task information 60 stored in task information store 42 of FIG. 1. As illustrated in FIG. 2, task information 60 is configured with input data set 61, output data set 63, program identifier 65, required processing time 66, and deadline 67.

Program identifier 65 is an identifier for identifying program 20 to be loaded to reconfigurable hardware 30 when a task is executed.

Input data set 61 is configured with one or more pieces of input data 62 to be used for processing a task. Each input data 62 may be actual data, or may be pointer information such as an address for identifying an input output data area stored in input output data store 110.

Output data set 63 is configured with one or more pieces of output data 64 in which the output of a result of a task process is stored. Output data 64 may be kept as a data area in task information 60, or may be pointer information such as an address for identifying an input output data area in which data of input output data store 110 is stored.

Required processing time 66 is an estimated value of a processing time necessary for reconfigurable hardware 30 to execute a task designated by task information 60. Deadline 67 stores a time limit for completion of a task execution.

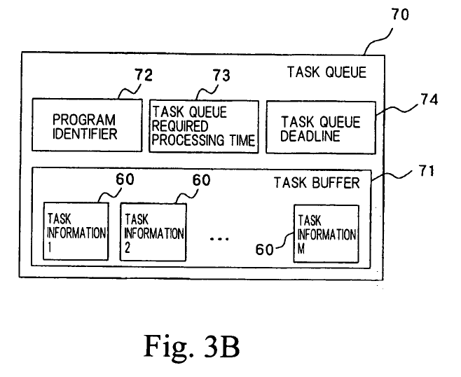

Next, FIG. 3A and FIG. 3B illustrate a configuration example of task queues 70 for managing a plurality of pieces of task information 60 for each program 20 in task information store 42 of FIG. 1.

As illustrated in FIG. 3A, task information store 42 stores task queues 70 for each program 20 stored in program store 41 illustrated in FIG. 1.

As illustrated in FIG. 3B, task queue 70 is configured with task buffer 71, program identifier 72, task queue processing time 73, and task queue deadline 74.

Task buffer 71 stores task information 60 of a plurality of tasks included in task queue 70.

Program identifier 72 stores an identifier of program 20 to be loaded to reconfigurable hardware 30 for executing a task designated by task information 60 stored in task buffer 71.

Task queue processing time 73 stores the required time necessary for executing tasks designated by all pieces of task information 60 stored in task buffer 71 of task queue 70. For example, task queue processing time 73 stores the total value of required processing times 66 of all pieces of task information 60 stored in task buffer 71.

Task queue deadline 74 stores a time limit for completion of execution of tasks indicated by all pieces of task information 60 stored in task buffer 71 of task queue 70. For example, task queue deadline 74 stores a minimum value of deadlines 67 of all pieces of task information 60 stored in task buffer 71.

Scheduler 45 illustrated in FIG. 1 manages program 20 to be loaded to reconfigurable hardware 30, and to be executed by referring to a plurality of pieces of task information 60 stored in task information store 42. Specifically, scheduler 45 selects a plurality of tasks which can be executed by the same program from task information store 42, selects a necessary program from program store 41, and controls the program to be loaded to reconfigurable hardware 30, and a plurality of tasks to be executed.

That is, scheduler 45 determines program 20 to be next loaded and a task to be next executed by referring to a plurality of pieces of task information 60 stored in task information store 42.

Such an operation will be described in which task information store 42, for example, manages task information 60 using a plurality of task queues 70 of each program 20 as illustrated in FIG. 3. Scheduler 45 adds a current time and task queue processing time 73 of each task queue 70, and calculates an estimated termination time when a task included in task queue 70 is started to be processed at the current time. Scheduler 45 calculates the difference between task queue deadline 74 of task queue 70 and the estimated termination time, and decides that the urgency of task queue 70, whose difference is the smallest, is the highest. Scheduler 45 selects task queue 70 whose urgency is high as above, and loads program 20 that is necessary for executing a plurality of tasks included in that task queue 70 to reconfigurable hardware 30, and after that, reconfigurable hardware 30 executes the tasks.

As described above, since a plurality of tasks are executed for one time of program loading to reconfigurable hardware 30, the program loading time can be relatively reduced. Information processing apparatus 10 of the present exemplary embodiment can execute by priority a plurality of tasks whose urgency is high by reducing the number of times of program loading, and can be also applied to a hard real-time application.

In FIG. 1, job information store 43 stores a plurality of pieces of job information 50. A large scale process may not be executed as one task by reconfigurable hardware 30 due to a limited amount of actual hardware, and the like. In such a case, the whole of process is divided into a plurality of small tasks, and each task is sequentially processed by reconfigurable hardware 30. A process unit configured with a plurality of tasks obtained by dividing the large scale process is referred to as a job. While the job is configured with a plurality of tasks, each task is not independent, but includes dependency relations. Thus, it is necessary to execute each task while keeping the dependency relations. The dependency relations include such a data dependency that the output of a task is used as the input of another task, and such a control dependency that it is necessary to execute another task after execution of the task is completed. Job information 50 is information indicating such dependency relations between each task included in a job.

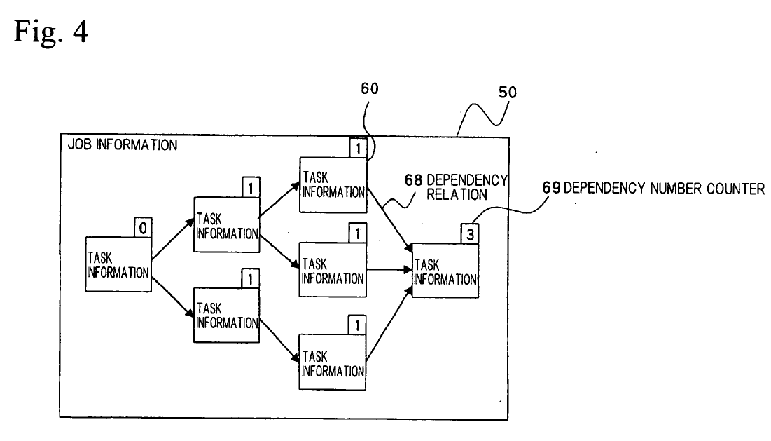

Next, FIG. 4 illustrates a configuration example of one job information 50 stored in job information store 43 of FIG. 1. This job information 50 stores a plurality of pieces of task information 60 included in a job and dependency relations 68 of the plurality of pieces of task information 60 as a graph. Each piece of task information 60 is provided with dependency number counter 69. An initial value of dependency number counter 69 is set when a job is generated. For example, when task 60 depends on the completion of the other two tasks 60, the initial value of dependency number counter 69 is set to two. When the execution of one task 60 is completed, task dependency relation 68 is traced, and dependency number counter 69 provided to task information 60 in the front is decreased by one. An executable task is task information 60 whose value of dependency number counter 69 becomes “0”. While dependency relation 68 includes the data dependency and the control dependency, dependency relation 68 can be totally managed by dependency number counter 69.

In FIG. 1, job manager 44 selects task information 60 of a task which becomes executable by referring to a plurality of pieces of job information 50 stored in job information store 43. Specifically, job manager 44 selects a task to be next executed according to the status for executing a task in a plurality of jobs, stores task information of the selected task in task information store 42, and updates and manages the job information according to the progress in executing the task.

In case of a configuration example of job information 50, as illustrated in FIG. 4, job manager 44 selects task information 60 whose value of dependency number counter 69 is “0”, and stores selected task information 60 in task information store 43. Job manager 44 may directly store selected task information 60 in task information store 42, or may notify selected task information 60 to scheduler 45, and store selected task information 60 through scheduler 45.

As illustrated in FIG. 3A, when task information store 42 is configured with task queue 70 for each program 20, job manager 44 stores task information 60 in task buffer 71 of task queue 70 including the same program identifier 72 that depends on program identifier 65 of selected task information 60. Scheduler 45 manages the schedule for loading a program and executing a task for task information 60 stored in task information store 42, and reconfigurable hardware 30 executes the task. Task information 60 of the task which is completed is notified from scheduler 45 to job manager 44. Job manager 44 changes job information 50 based on the completion notice from scheduler 45. In job information 50, dependency relations 68 is traced from task information 60 of the completed task, and dependency number counter 69 of task information 60 of a task depending on the completed task is decreased. It can be managed by using information such as task identifier, which task information 60 of a plurality of pieces of job information 50 stored in job information store 43 corresponds to task information 60 of the completed task.

As described above, even when there are a plurality of job whose structures are different from each other, and even when such jobs are dynamically generated, tasks can be executed while keeping the dependency relations of the tasks included in the jobs.

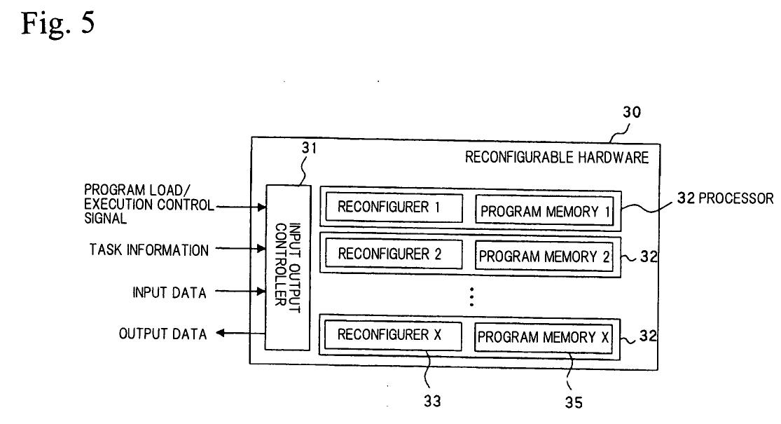

FIG. 5 illustrates a configuration example of reconfigurable hardware 30 of FIG. 1. As illustrated in FIG. 5, reconfigurable hardware 30 is configured with input output controller 31 and one or more processors 32. Each of processors 32 is configured with reconfigurer 33 and program memory 35. The hardware configuration of reconfigurer 32 is changed and a prescribed process is executed according to the content of program 20 loaded to program memory 35. Input output controller 31 is provided for an interface to the outside, and through input output controller 31, program 20 can be loaded from the outside of reconfigurable hardware 30 to program memory 35, and an execution of a process in processor 32 can be controlled.

Input output controller 31 receives task information 60 to deliver input data stored in input output data store 110 to processor 32 according to received task information 60, and outputs the process result in processor 32 as output data to input output data store 110. When there is a plurality of processors 32, while programs 20 are being executed by one or more processors 32, program 20 can be loaded to another processor 32 which is not executing programs. As described above, a plurality of programs 20 can loaded in reconfigurable hardware 30, and when program 20 can be executed and also when program 20 can be loaded at the same time, while a plurality of tasks which can be executed by one program 20 are being executed, another program 20 can be loaded, so that the program loading time can also be completely hidden.

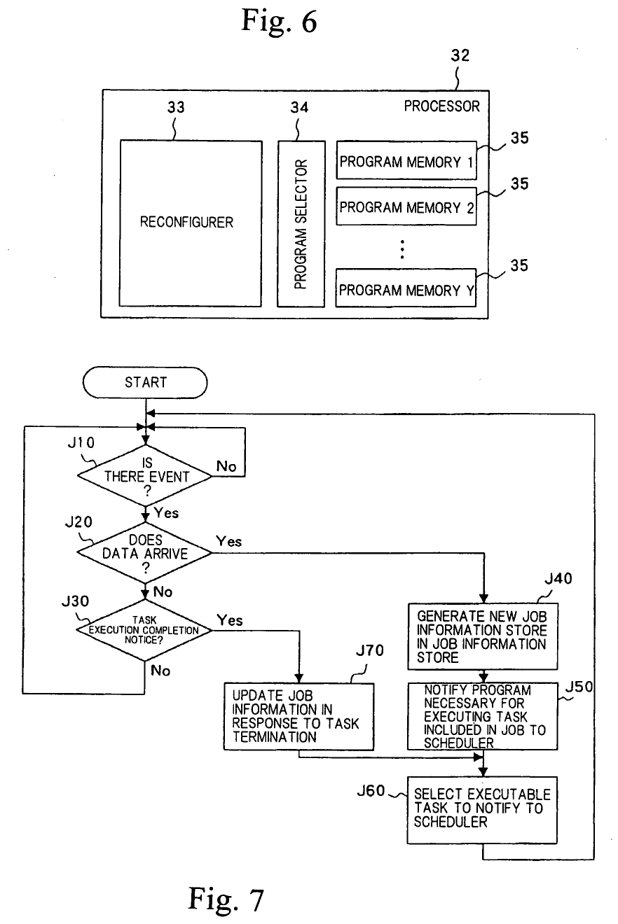

Next, FIG. 6 illustrates another configuration example of processors 32 of FIG. 5. In this case, as illustrated in FIG. 6, processor 32 is configured with reconfigurer 33, a plurality of program memories 35, and program selector 34. Program selector 34 selects one program memory 35 from a plurality of program memories 35, and a hardware configuration of reconfigurer 33 is changed according to program 20 stored in selected program memory 35. Program selector 34 can select program memory 35 in a shorter time than the time in which the program is loaded to program memory 35. If all necessary programs 20 are previously loaded in program memory 35, programs 20 can be switched without an overhead for the program loading after the loading. One program memory 35 is selected, and while program 20 stored in selected program memory 35 is being executed in reconfigure 33, program 20 can be loaded to another unselected program memory 35. Thus, even when it is necessary to load more programs 20 than a plurality of program memories 35, the program loading time can be hidden.

Next, operations of the information processing apparatus of the present exemplary embodiment will be described in detail by referring to the drawings.

First, FIG. 7 is a flowchart illustrating an operation example of job manager 44 of FIG. 1. It is assumed that job manager 44 applies a previously-designated process to data according to the data arrival from the outside, and outputs the result. And it is assumed that job manager 44 receives two types of events, data arrival events from the outside and the task execution completion notice from scheduler 45.

First, job manager 44 waits for an event arrival (step J10). When the event is the data arrival from the outside (step J20), job manager 44 newly generates job information 50 necessary for processing the data to store generated job information 50 in job information store 43 (step J40).

Next, job manager 44 stores necessary program 20 in program store 41 by notifying program 20 that is required for executing a task included in the job to scheduler 45 (step J50). The preparation necessary for executing the task included in the job is performed with the above operation. Job manager 44 refers to a plurality of pieces of job information 50 stored in job information store 43, selects task information 60 whose dependency number counter 69 is “0”, and notifies selected task information 60 to scheduler 45 (step J60). Thereby, selected task information 60 is stored in task information store 42.

When the event is the task execution completion notice from scheduler 45 (step J30), job manager 44 updates corresponding job information 50 according to task information 60 of a task whose execution has been completed (step J70). A task which becomes newly executable may be generated by updating job information 50, so that job manager 44 selects the executable task to notify the task to scheduler 45 (step J60).

In the above operation example of job manager 44, a job is divided into units, which are tasks that can be independently executed by reconfigurable hardware 30 respectively, and the dependency relation between the tasks is dynamically managed according to progress in executing the tasks, so that even if a plurality of jobs are dynamically generated according to data arrival, reconfigurable hardware 30 can efficiently process the jobs.

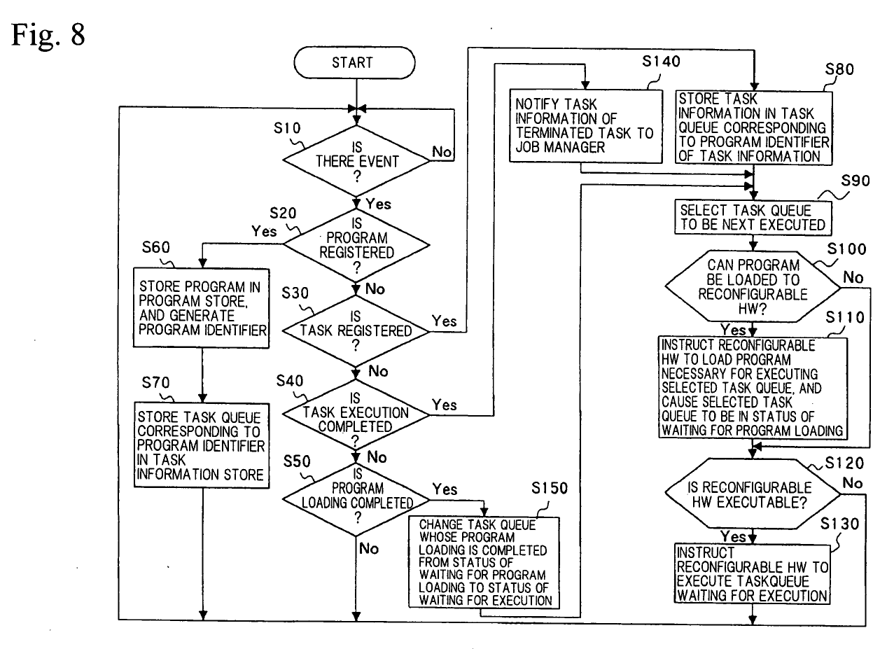

Next, FIG. 8 is a flowchart illustrating an operation example of scheduler 45 of FIG. 1. It is assumed that scheduler 45 receives notice events of registering a program from job manager 44 (step J50 of FIG. 7), a notice for registering a task (step J60 of FIG. 7), and a task execution completion notice from reconfigurable hardware 30. It is assumed that scheduler 45 can confirm the operation status of reconfigurable hardware 30 when executing the operation. This can be performed by providing reconfigurable hardware 30 with a register indicating the operation status, or by providing scheduler 45 itself with a status parameter indicating execution control status to reconfigurable hardware 30, and by changing the status parameter according to control in reconfigurable hardware 30, and according to a status notice from reconfigurable hardware 30.

Scheduler 45 loads and executes program 20 for each task queue 70. Task queue 70 transits between several statuses as managed by scheduler 45. Main status includes a program loading waiting status in which the loading of the program that needs to be executed by reconfigurable hardware 30 is being waited, and includes an execution waiting status in which the execution of program 20 by reconfigurable hardware 30 is being waited.

First, scheduler 45 waits the event to arrive (step S10). Next, when the event is a notice for registering the program from job manager 44 (step S20), scheduler 45 stores designated program 20 in program store 41, and generates a program identifier for managing stored program 20 (step S60). Next, scheduler 45 generates task queue 70 for managing task information 60 which can be executed by registered program 20 in task information store 42, and causes task information 60 to be able to be uniquely identified by the program identifier generated at step S60 (step S70).

When the event is a notice for registering a task from job manager 44 (step S30), scheduler 45 refers to program identifier 65 of designated task information 60 to store designated task information 60 in corresponding task queue 70 of task information store 41. Scheduler 45 also updates the status of task queue 70 such as task queue processing time 73 and task queue deadline 74 of task queue 70 in response to storing task information 60 (step S80).

As described above, the status of task queue 70 of task information store 42 is changed. Thus, scheduler 45 compares values of the status of task queue 70 such as task queue processing time 73 of each task queue 70 and task queue deadline 74, and selects task queue 70 whose urgency is high (step S90). Next, scheduler 45 confirms the operation status of reconfigurable hardware 30 (step S100), and if the program can be loaded, instructs reconfigurable hardware 30 to load program 20 that is needed to execute selected task queue 70, and causes selected task queue 70 to be in the program loading waiting status representing the waiting status for the program that is to be loaded (step S110). Next, scheduler 45 confirms the operation status of reconfigurable hardware 30 (step S120), and if a task can be executed, instructs reconfigurable hardware 30 to execute task queue 70 in the execution waiting status. When reconfigurable hardware 30 can execute a plurality of task queues 70 at the same time, and also, when there are a plurality of task queues 70 in the execution waiting status, reconfigurable hardware 30 can more efficiently execute the instruction for executing a plurality of task queues 70 (step S130). Steps S90, S100, S110, S120, and S130 are important for the scheduling by scheduler 45.

When the event is the task execution completion notice from reconfigurable hardware 30 (step S40), scheduler 45 informs task information 60 of the completed task to job manager 44. When the task execution completion notice from reconfigurable hardware 30 is performed for each task queue 70, scheduler 45 can also inform task information 60 to job manager 44 for each task queue 70 (step S140). If the execution of task queue 70 is completed, the status of reconfigurable hardware 30 and the status of task queues 70 are changed, so that scheduler 45 executes operations of steps S90, S100, S110, S120, and S130 which are main parts of the scheduling.

When the event is a notice for completing the program that is being loaded from reconfigurable hardware 30 (step S50), scheduler 45 changes the status of task queue 70 corresponding to program 20 whose program loading has been completed from the program loading waiting status to the execution waiting status (step S150). Since the status of reconfigurable hardware 30 and the status of task queue 70 are changed, scheduler 45 executes operations of steps S90, S100, S110, S120, and S130 which are main parts of the scheduling.

In the above operation examples of scheduler 45, by managing a plurality of tasks, which can be executed by the same program 20, as a unit of task queue 70, the time necessary for the program loading is caused to be relatively small as compared with the time necessary for executing the tasks, so that the overhead of the program loading time can be reduced when reconfigurable hardware 30 executes a plurality of the programs. When reconfigurable hardware 30 can execute program 20 and load program 20 at the same time as illustrated in FIG. 5 and FIG. 6, since reconfigurable hardware 30 can load program 20 together with another program 20 in parallel, the overhead for the program loading becomes can also be effectively eliminated.

In information processing apparatus 10 of the present exemplary embodiment, since reconfigurable hardware 30 executes a plurality of tasks which can be processed by the same program 20 as a whole, the time necessary for the program loading can be caused to be relatively small as compared with the execution time. Thus, in information processing apparatus 10 that uses reconfigurable hardware 30, when the program of reconfigurable hardware 30 is loaded according to the process, the overhead of the program loading time can be caused to be small, and a large scale of process can be also efficiently processed in the reconfigurable hardware of which hardware scale is limited.

Information processing apparatus 10 of the present exemplary embodiment, can manage the whole of process with a structure which is a job including a plurality of tasks, dynamically select a task to be next executed according to the status in executing a task in the job, and dynamically manage the schedule for executing the task and the program loading necessary for executing the task. Thus, in information processing apparatus 10 using reconfigurable hardware 30, even when the schedule for executing the task and the program loading, and the like can not be previously statically determined, the process can be efficiently executed by dynamically managing the process progress.

Since a time for loading the program of reconfigurable hardware 30 can be effectively eliminated, the information processing apparatus of the present exemplary embodiment can be applied to a usage for streamlining a communication, a network process, a multi-media process, and the like in which a necessary process is changed according to the data arrival from the outside, and a time is limited for transferring the process result.

### Second Exemplary Embodiment

Next, an information processing apparatus of the second exemplary embodiment of the present invention will be described.

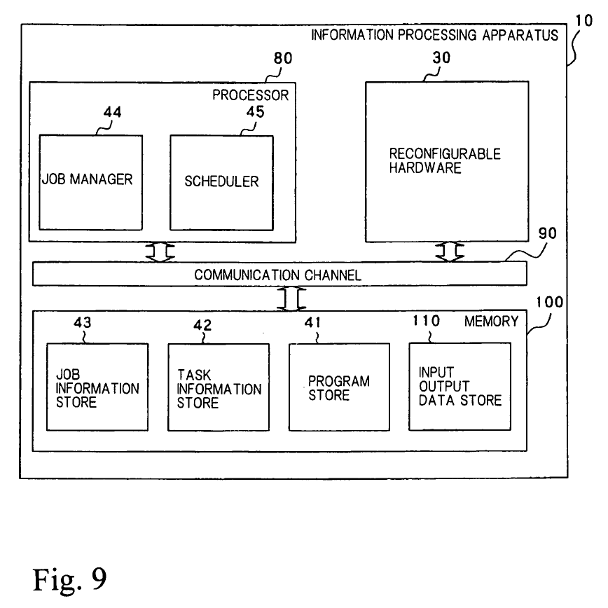

In the second exemplary embodiment of the present invention, while the basic configuration is the same as that of the above first exemplary embodiment, in the configuration illustrated in FIG. 9, job manager 44 and scheduler 45 are realized as software that is executed on processor 80. In this configuration, job information store 43, task information store 42, program store 41, and input output data store 110 can be realized as an area on memory 100 respectively. Processor 80, reconfigurable hardware 30, and memory 100 can communicate information and control through communication channel 90. For example, the event notice from reconfigurable hardware 30 can be realized as an interrupt to processor 80. Job manager 44 and scheduler 45 may be realized as one program, or may be as a parallel program such as a multithread.

1. An information processing apparatus, comprising:
reconfigurable hardware being able to load one or more programs according to process content of a task to be executed, and being able to execute one or more programs of the one or more loaded programs at the same time;
an input output data store storing input output data to be processed in the reconfigurable hardware; and
a controller controlling to load a program to the reconfigurable hardware and execute the program,
the controller including:
a program store storing a plurality of programs to be loaded to the reconfigurable hardware;
a task information store storing task information indicating a plurality of tasks executable by the same program for each program stored in the program store;
a job information store storing job information indicating dependency relation between each task included in a job, the job being a group of process units configured with the plurality of tasks;
a job manager selecting an executable task according to the job information, storing task information of the selected task in the task information store, and updating the job information according to progress in executing the task; and
a scheduler selecting one or more tasks executable by the program from the task information store, selecting a program necessary for executing the selected task from the program store, loading the selected program to the reconfigurable hardware and managing the schedule, controlling the reconfigurable hardware to execute the task and managing the schedule, and notifying progress status in executing the task to the job manager.

2. The information processing apparatus according to claim 1,
wherein the job manager selects a task to be next executed while keeping a dependency relation between each task, the dependency relation being indicated by the job information stored in the job information store.

3. The information processing apparatus according to claim 1,
wherein the task information includes:
an input data set including one or more input data indicating input data of the task;
an output data set including one or more output data indicating a storing area of an output result of the task;
a program identifier for identifying the program necessary for executing the task;
a required processing time necessary for executing the task in the reconfigurable hardware; and
a deadline representing a time until which it is necessary to complete processing the task.

4. The information processing apparatus according to claim 1,
wherein the task information store is configured with a plurality of task queues corresponding to each of the plurality of programs, and stores the plurality of tasks processable by the corresponding program in the task queue, and
the scheduler loads the program to the reconfigurable hardware for each task queue and manages the schedule, and controls the reconfigurable hardware to execute the plurality of tasks and manages the schedule.

5. The information processing apparatus according to claim 4,
wherein the task queue includes:
a task information buffer storing the plurality of pieces of task information;
the program identifier;
a task queue processing time necessary for processing the plurality of pieces of task information stored in the task information buffer; and
a task queue deadline by which it is necessary to complete processing the plurality of tasks stored in the task information buffer,
the scheduler loads a program to the reconfigurable hardware and manages the schedule, and controls the reconfigurable hardware to execute a plurality of tasks and manages the schedule for each task queue based on the task queue processing time and the task queue deadline.

6. The information processing apparatus according to claim 1,
wherein the reconfigurable hardware includes:
an input output controller controlling to load and execute the program, input the task information, input the input data set, and output the output data set; and
one or more processors executing a process of the task according to the program and the task information.

7. The information processing apparatus according to claim 6,
wherein the processor includes:
a program memory storing the program; and
a reconfigurer being able to change a hardware configuration according to the program loaded in the program memory.

8. The information processing apparatus according to claim 6,
wherein the processor includes:
a plurality of program memories storing the plurality of programs;
a program selector selecting one program memory from the plurality of program memories;
a reconfigurer being able to change a hardware configuration according to the program stored in the selected program memory; and
a loader loading the program to another program memory at the same time when a task process is executed in the reconfigurer by one selected program memory.

9. A information processing apparatus, comprising:
reconfigurable hardware being able to load one or more programs according to process content of a task to be executed, and being able to execute one or more programs of the one or more loaded programs at the same time;
input output data store means for storing input output data to be processed in the reconfigurable hardware; and
control means for controlling to load a program to the reconfigurable hardware and execute the program,
the control means including:
program store means for storing a plurality of programs to be loaded to the reconfigurable hardware;
task information store means for storing task information indicating a plurality of tasks executable by the same program for each program stored in the program store means;
job information store means for storing job information indicating dependency relation between each task included in a job, the job being a group of process unit configured with the plurality of tasks;
job manage means for selecting an executable task according to the job information, storing task information of the selected task in the task information store means, and updating the job information according to progress in executing the task; and
schedule means for selecting one or more tasks executable by the program from the task information store means, selecting a program necessary for executing the selected task from the program store means, loading the selected program to the reconfigurable hardware and managing the schedule, controlling the reconfigurable hardware to execute the task and managing the schedule, and notifying progress status in executing the task to the job manage means.

10. An information processing method performed by an information processing apparatus which comprises a reconfigurable hardware being able to load one or more programs according to process content of a task to be executed, and being able to execute one or more programs of the one or more loaded programs at the same time, said method comprising:
storing a plurality of programs to be loaded to the reconfigurable hardware;
storing task information indicating a plurality of tasks executable by the same program for each stored program;
storing job information indicating a dependency relation between each task included in a job, the job being a group of process units configured with the plurality of tasks;
selecting an executable task according to the job information, storing task information of the selected task,
selecting one or more tasks executable by the stored program, selecting a program necessary for executing the selected task based on the task information, loading the selected program to the reconfigurable hardware and managing the schedule, controlling the reconfigurable hardware to execute the task and managing the schedule, and
updating the job information according to progress in executing the task.
